(19) United States
(12) Patent Application Publication
(10) Pub. No.: US 2017/0259860 A1
(43) Pub. Date: Sep. 14, 2017

(54) Automatic Track Drive Tensioner

(71) Applicant: Mototrax, LLC, Moscow, ID (US)

(72) Inventor: Randy Gentry, Moscow, ID (US)

(21) Appl. No.: 15/063,908

(22) Filed: Mar. 8, 2016

(51) Int. Cl. B62D 55/30; B62D 55/32

(52) U.S. Cl. CPC B62D 55/30; B62D 55/32; B62M 27/02

(57) ABSTRACT

A system and method for automatically adjusting the tension of a track on a snow machine, or other track-driven vehicle, is disclosed. The system includes an axle mounted in slotted adjustment holes with an axle bolt or other means to fix the axle to the track guide of the track-driven machine. The system also includes one or more biasing members to exert a force on the axle. When an axle bolt is loosened, the axle moves forward or backward in the adjustment slots to achieve the proper tension on the track. The axle bolt can then be tightened to fix the location of the axle in the adjustment slots at the location that provides proper tension for the track. The system obviates the need to use complicated tools and procedures to properly tension the track.

### BACKGROUND

Snow machining is a popular winter sport. Snow machines have evolved from basic winter transportation used in remote areas to a fully developed motorsport. Long travel suspensions and powerful engines have enabled ski machines to compete in arenas formerly occupied only by motorcycles and bicycles. Events involving ski machines include ski machine motocross, free-style jumping, and cross country racing, among other things.

Snow machines, snow cats, snow bikes, and other vehicles often use track drives. The tracks can be attached to the engine in a similar manner to that used for military track drives, such as on tanks and half-tracks. The tracks are wide and offer a lower surface pressure than a standard wheel, for example, to help prevent sinking in snow, sand, or other loose material. The tracks can be equipped with different “tread” patterns to handle different conditions. The tracks may be equipped with deep paddles, for example, for use in mud or deep snow.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a right, perspective view of an automatic tensioning system for a track guide on a track-driven vehicle, in accordance with some examples of the present disclosure.

FIG. 2 depicts a right, rear, perspective view of the automatic tensioning system of FIG. 1, in accordance with some examples of the present disclosure.

FIG. 3 depicts a right view of the automatic tensioning system of FIG. 1, in accordance with some examples of the present disclosure.

FIG. 4 is a flowchart depicting an exemplary process for automatically adjusting a track tension on a track-driven vehicle using the system of FIG. 1, in accordance with some examples of the present disclosure.

### DETAILED DESCRIPTION

As mentioned above, there are a number of vehicles that use track drives. Snow machines and snow bikes, for example, often use wide, flexible tracks with a variety of tread features depending on what type of terrain and conditions will be encountered. Snow machine tracks were originally manufactured from steel reinforced rubber, similar to a car tire. Modern tracks tend to comprise composite materials, however, such as Kevlar®.

Regardless of their composition, however, the tracks stretch over time. In addition, due in part to their large width, they may also stretch in a slightly nonlinear manner. In other words, due to the layup of materials and/or belts inside the track, manufacturing tolerances, drive systems, and other factors, the track may stretch slightly more in the middle than on the sides (or vice-versa), or may stretch more on one side than the other. As a result, tensioning the track can be a time consuming and tedious process.

In many cases, the vehicle must be run to bring the track up to operating temperature and then the vehicle must be supported on a jack, stand, or lift such that the track is off the ground. The adjusters, axle bolts, or other fasteners securing the axle for the track are then loosened and a weight is hung from a predetermined location on the vehicle's swingarm. The adjusters are then tightened and the vehicle is ridden again to bring the track back up to temperature. The vehicle is then placed back on the stand or lift to recheck the tension of the track. The process can take an experienced mechanic 30 minutes or more. Obviously, a novice may take considerably longer.

To this end, examples of the present disclosure can comprise a system for automatically tensioning the track of a track-driven vehicle, such as a snow machine or a snow bike. The system can enable the user to simply loosen the fixing mechanism (e.g., the axle) on the vehicle. When loose, one or more biasing elements can provide the necessary tension in an even manner such that, when then adjusters are tightened, no further adjustment or checks are necessary. The system can also eliminate specialized tools such as weights, track tension gauges, and adjusters, which are required when using conventional track adjustment mechanisms.

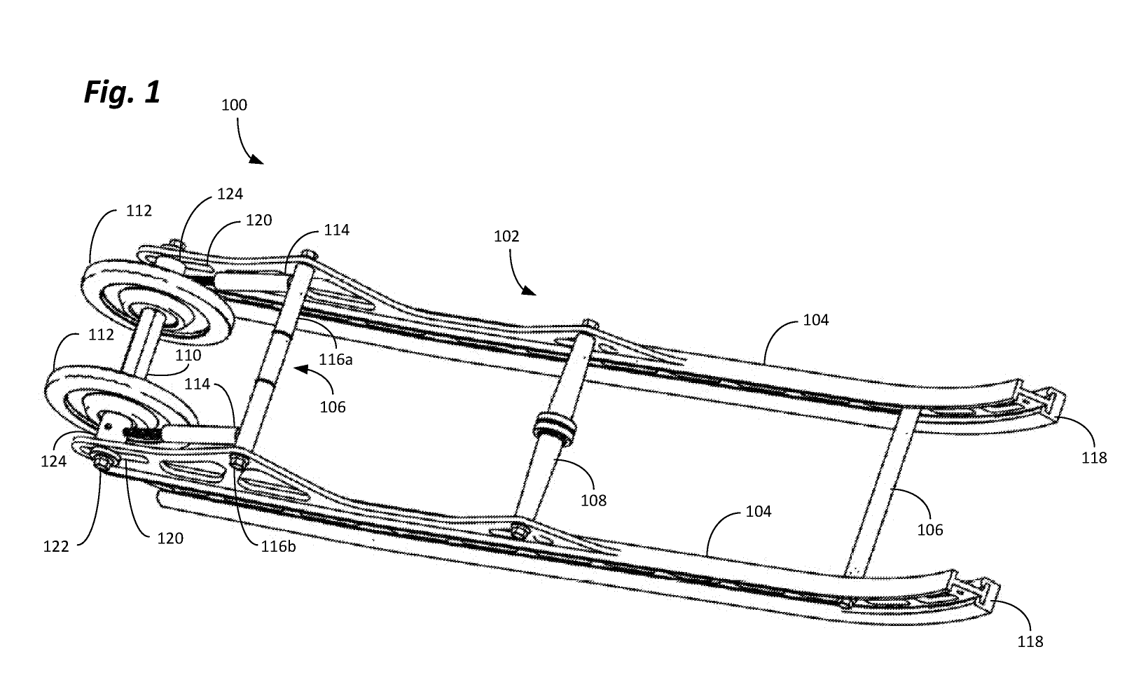

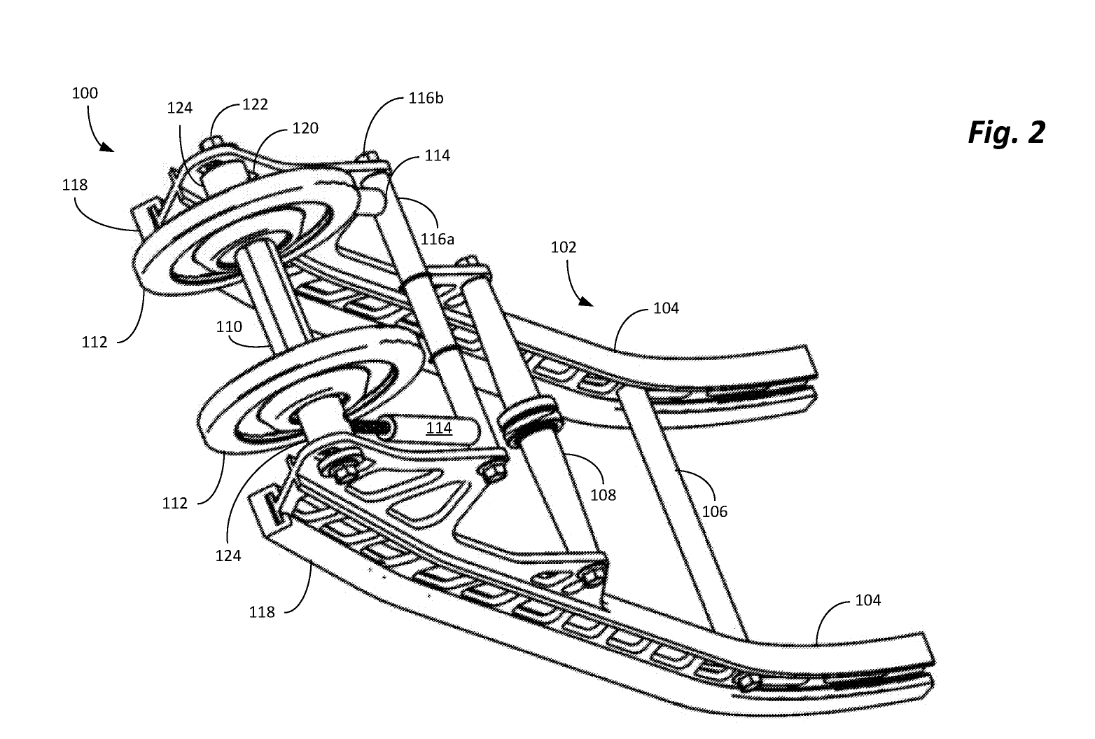

As shown in FIGS. 1 and 2, the system 100 can comprise a track guide 102 for guiding a track (not shown) on a track-driven vehicle. The track guide 102 can include frame members 104 and one or more cross members 106. One or more of the cross members 106 can also act as a roller, or guide 108 for the track. The system 100 can also include an axle 110, one or more idlers 112, and one or more biasing members 114.

As shown, in some examples, the frame members 104 and cross members 106 can provide the basic framework for the track guide 102. The frame members 104 can comprise a suitably light, strong material such as, for example, steel, plastic, carbon fiber, plastic, or other composite material. The frame members 104 are preferably aluminum. In some examples, the cross members 106 can comprise one or more spacers 116a and one or more bolts 116b. In this manner, the cross members 106 can set the spacing and provide rigidity to the track guide 102. In some examples, the cross members 106 can also comprise one or more guides 108, or rollers, to promote proper alignment of the track and to reduce friction between the track and the system 100.

In some examples, the frame members 104 can also comprise one or more wear guards 118. As the name implies, the wear guards 118 can be disposed in an overlying manner to the surfaces of the frame members 104 that come in contact with the track. In this manner, the wear guards 118 can be sacrificial (i.e., the wear guards 118 can act as a wear surface) to prevent damage to the frame members 104 caused by the friction of the track over the frame members 104. In some examples, the wear guards 118 can also provide a lower coefficient of friction between the frame members 104 and the track. In this configuration, the wear guards 118 can comprise a material that is very hard, contains inherent lubricity, or otherwise lowers the friction between the track and the wear guards 118.

In some examples, the wear guards can comprise a hard plastic or composite such as, for example, ultra-high molecular weight (UHMW) polyethylene (e.g., TIVAR®), Kevlar®, or nylon. In some examples, the wear guards 118 can be detachably coupled to the frame members 104 to facilitate their replacement when sufficiently worn. The wear guards 118 can be, for example, slid over a channel on the frame members 104 and/or bolted, screwed, clipped, or otherwise secured to the frame members 104.

As mentioned above, tracks stretch over time. Thus, when it is new, a track is at its minimum length (and the axle 110 is in the forward most position). As the track wears, the overall length of the track increases, necessitating adjustment to maintain the same track tension. When the track has reached a maximum predetermined length (i.e., the axle 110 has reached the limit of its rearward adjustment), the track is considered to be worn out and needs to be replaced. Failure to do so can result in the track breaking and/or slipping on the drive due to a lack of tension. The tension can be adjusted by moving the axle 110 rearward in adjustment slots 120 in the frame members 104 to increase the tension of the idlers 112 on the track.

The idlers 112 can comprise a suitably hard, yet resilient material to enable them to contact and tension the track. In some examples, the idlers 112 can comprise rubber tires, plastic wheels, or rollers in contact with the track. In some examples, the idlers 112 can also comprise teeth, or other means, to engage with the track. In other examples, the idlers 112 can also comprise a groove, similar to the groove shown in the guide 108, to maintain the alignment of the track. In this configuration, the idlers 112 can not only tension the track, but also maintain the alignment of the track. In some examples, the idler 112 can also comprise a continuous roller, or spool, spanning a majority of the axle 110.

As mentioned above, in some examples, the frame members 104 can define one or more adjustment slots 120 to enable the axle 110 to move forward and backward in the frame members 104. This enables the idlers 112 to move backward and forward to tension the track. The axle 110 can be affixed to the system 100 using one or more axle bolts 122, or similar. In this manner, when the axle bolt 122 is tightened to a predetermined tightening torque, the axle 110 is substantially fixed to the frame members 104 in the adjustment slots 120. When the axle bolt 122 is loosened, on the other hand, the axle 110 is free to move back and forth in the adjustment slots 120 to affect adjustment of the track tension.

The system 100 can also include one or more adjustment collars 124. In some examples, the biasing members 114 can comprise a first end 114a and a second end 114b. The first ends 114a of the biasing members 114 can be pivotally coupled to the frame member 104 or a cross member 106. The second ends 114b of the biasing members 114 can be pivotally coupled to the adjustment collars 124. This can enable the biasing members 114 to transmit the adjusting force to the axle 110, though the movement of the axle 110 in the adjustment slots 120 and the force provided by the biasing members 114 may not be parallel. In some examples, as shown, the axle 110 can be disposed through, or attached to, the adjustment collars 124.

In some examples, as shown, the axle bolt 122 can comprise a single through-bolt that passes through the adjustment collars 124, axle 110, and adjustment slots 120. The axle bolt 122 can also comprise one or more washers and/or nuts to secure the axle bolt to the track guide 202. In some examples, the axle bolt 122 can comprise a stud with nuts and washers threadably engaged on both ends. In still other embodiments, the ends of the axle 110 or adjustment collars 124 can be threaded and the axle bolt 122 can comprise two bolts threaded into the axle 110 or adjustment collars 124 from the outside of the frame members 104.

The biasing members 114 can comprise units suitable to provide the proper tension to the track. In some examples, the biasing members 114 can comprise, for example, hydraulic cylinders or springs suitable to provide this tensioning force. In other examples, the biasing members 114 can comprise pneumatic shocks similar to those used for hood and hatch struts on vehicles.

The track tension can vary from machine to machine based on horsepower, torque, track length, track width, swingarm length, and track material and tread pattern, among other things. To this end, the gas and/or hydraulic pressure and piston size of the biasing members 114 can enable the biasing members 114 to be designed and/or adjusted to provide the proper tension for different tracks. In some examples, the biasing members 114 can also comprise Schrader valves, or similar, to enable adjustment of the tension via pressurized gas (e.g., air or nitrogen). In this manner, a single biasing member 114, or set of biasing members 114, can be used with a variety of different types of tracks. In other examples, different biasing members 114 can be designed for each vehicle or based on type of track, tread pattern, engine size, etc.

In some examples, the biasing members 114 can be sized and shaped such that they provide substantially consistent tension throughout the range of motion of the axle 110. In some examples, this can be achieved by using an appropriately sized piston and body for the biasing member 114. In other examples, the range of adjustment of the adjustment slot 120 can be suitably small (i.e., short) in comparison to the stroke of the biasing member 114 such that any changes in the force exerted by the biasing members 114 from the forward most position to the rear most position are negligible. In still other examples, the biasing members 114 can employ pulleys, eccentrics, levers, or other means to maintain a constant force on the axle 110 throughout its travel.

In addition to requiring periodic adjustment to track tension, the track may also have a range of allowable tensions (e.g., tension to between 20-25 ft./lbs.). To this end, in some examples, the biasing members 114 can be configured to provide the maximum allowable tension when the track is new (i.e., axle forward) and the minimum allowable tension when the track reaches its maximum allowable length (i.e., axle rearward). In this manner, though the tension decreases slightly as the track stretches and the axle 110 moves rearward, the tension of the track is nonetheless maintained within allowable limits.

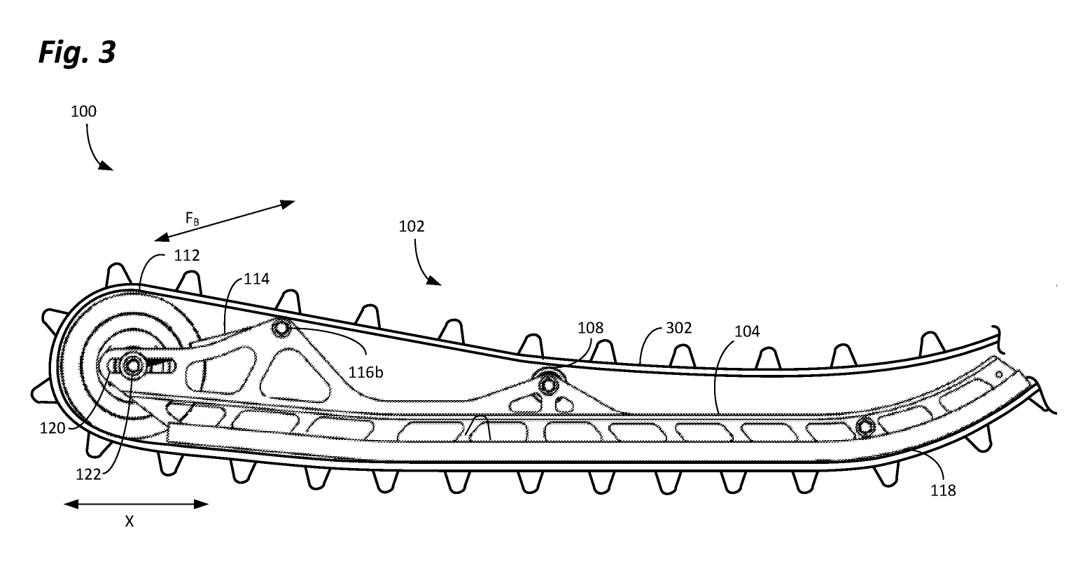

As shown in FIG. 3, the biasing members 114 can exert a force, F_{B}, on the axle 110 via the adjustment collars 124 (or other suitable means). F_{B}, in turn, can cause the axle 110 to move rearward in the adjustment slots 120 of the frame members 104. As discussed above, the biasing members 114 can be designed such that F_{B} provides the desired tension to a track 302 mounted on the track guide 102. The biasing members 114 can be hydraulic, pneumatic, or spring-actuated, for example, to provide the desired force, F_{B}. In some examples, F_{B} can be adjusted by adjusting, for example, the spring pre-load or air pressure in the biasing members 114.

As shown, the biasing members 114 can be pivotally coupled to the frame members 104 and the axle 110 to enable them to move through the range of motion of the axle 110 without binding. In some cases, the biasing members 114 can be mounted parallel to the adjustment slots 120, such that F_{B} is substantially parallel to the direction of adjustment for the axle 110. In other example, as shown, the biasing members 114 can be disposed at an angle to the adjustment slots 120. This may be more convenient from a packaging perspective, for example.

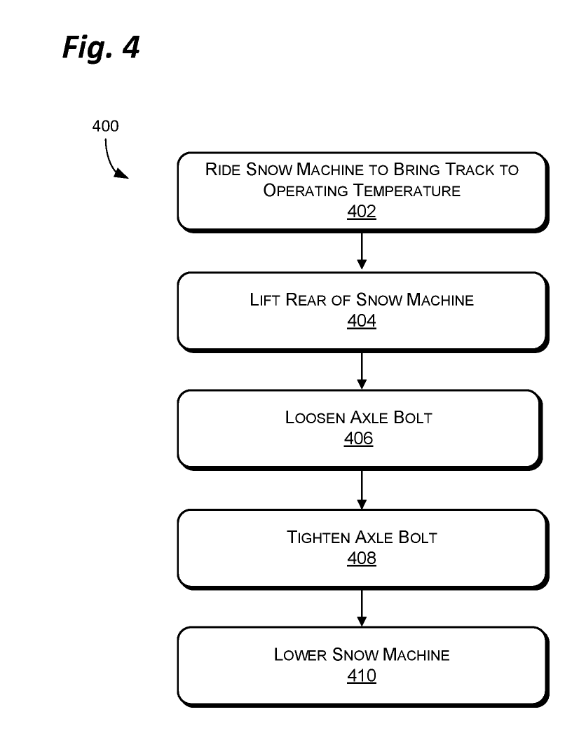

As discussed below with respect to FIG. 4, to adjust the track 302 tension, the user need only loosen the axle bolt 122, allow the axle 110 to move rearward in the adjustment slots 120. When the resistance from the tension on the track 302 equals F_{B} (i.e., the two forces equalize), the axle 110 will stop, and the user can re-tighten the axle bolt 122. In this manner, the tension of the track 302 can be adjusted automatically with no special tools and/or skills required.

As mentioned above, in some examples, the track 302 may stretch unevenly across its width. This may be due to slight manufacturing defects or variances in the track 302 material. Regardless, in some examples, the system 100 can comprise at least two biasing members 114 disposed on opposite sides of the axle 110. In this manner, when the axle bolt 122 is loosened, the biasing members 114 can apply equal force to each side of the axle 110. This enables the track 302 to be evenly tensioned despite any slight differences in wear on the track 302. It is possible, of course, that the axle 110 may become slightly skewed, but this slight misalignment is immaterial to the operation of the machine. More importantly, evenly tensioning the track 302 increases the life of the track 302 and also reduces wear on other drivetrain components (e.g., the idlers 112 and guides 108).

The use of the biasing members 114 obviates the need to use complicated tensioning procedures to ensure the track 302 is properly tensioned. As shown in FIG. 4, the process 400 is vastly simplified over conventional tensioning techniques that often require special weights or gauges to properly tension the track 302. At 402, the user can ride the machine until the track 302 has reached operating temperature. As with most driveline components, the temperature of the track 302 increases slightly with use, eventually normalizing to a standard operating temperature. Thus, the track 302 may elongate slightly as it warms to operating temperature. In addition, the track 302 may become more flexible enabling it to be properly tensioned.

At 404, the user can lift the snow machine, or at least the rear of the snow machine, off the ground such that the rear swingarm and track 302 is unloaded. In some examples, this can be achieved using a floor jack or stand. In other examples, the user may lift the entire vehicle off the ground with a hydraulic or pneumatic lift for this purpose—e.g., similar to an automotive lift.

At 406, the user can loosen the axle bolt 122 (or other axle retainer, as applicable). In this manner, the axle 110 is free to move backward and forward in the adjustment slots 120. In addition, when the axle bolt 122 is loosened, the biasing members 114 are free to act on the axle 110 via the adjustment collars 124 (or other suitable means). Thus, if the track 302 is too loose, the force provided by the biasing members 114, F_{B}, will overcome the tension of the track 302 and the axle 110 will move rearward in the adjustment slots 120, and vice versa. Of course, because tracks 302 tend to stretch over time and not shrink, the opposite would likely only be true if the track 302 has somehow been manually over tightened, for example.

At 408, because the biasing members 114 evenly and automatically tension the track 302 to the proper tension, once equalized, the user need only tighten the axle bolt 116b. Due to the design of the biasing members 114, the axle 110 is automatically moved to the proper location in the adjustment slots 120 to provide proper tension on the track 302. In addition, when two or more tensioning members 114 disposed evenly on the axle 110 are incorporated, the track 302 tension is also set from side to side. Properly and evenly tensioning the track 302 increases the life of the track 302 and the related components (e.g., the idlers 112 and the guides 108). As mentioned above, if the track 302 has worn unevenly, this may result in the axle 110 being slightly skewed. This is immaterial to the functioning of the track 302, however.

At 410, the user can then simply lower the machine back onto the ground. There is no need for special tools or weights to properly tension the track 302. There is also no need to ride the machine and then recheck the tension. The system 100 greatly reduces the complexity of adjusting the tension of the track 302. The system 100 also reduces the time required to adjust the tension. In addition, properly and evenly adjusting the tension of the track 302 increases the life of the track 302 and associated components.

The terms “snow machine” and “track” are used herein to simplify the disclosure. These terms are not intended to limit the disclosure. As used herein, the term snow machine could also refer to other track-driven vehicles such as, for example, snow bikes, snow cats, tanks, bulldozers, and bobcats. Similarly, the term “track” is used to describe a continuous, flexible track with a tread pattern as is commonly found on a snow machine. The system could also be used on other machines with belts such as, for example, drive belts, fan belts, and accessory belts, among other things.

The specific configurations, choice of materials, and the size and shape of various elements can be varied according to particular design specifications or constraints requiring a device, system, or method constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

What is claimed is:

1. A system comprising:
an axle, with a first end, a second end, a forward position, and a rearward position;
a first idler mounted on the axle and in rotatable contact with a track of a track-driven vehicle; and
a first biasing member, with a first end and a second end, the first end pivotally coupled to a frame member of the track-driven vehicle and the second end pivotally coupled to the axle;
wherein the first biasing member exerts a force, F_{B}, on the axle to move the axle between the forward position and the rearward position to tension the track.

2. The system of claim 1, further comprising:
a second biasing member, with a first end and a second end, the first end pivotally coupled to the frame member of the track-driven vehicle and the second end pivotally coupled to the second end of the axle;
wherein the first biasing member is pivotably coupled to the first end of the axle.

3. The system of claim 1, wherein the first biasing member comprises a pneumatic shock absorber.

4. The system of claim 1, wherein the first biasing member comprises a pneumatic and hydraulic shock absorber.

5. The system of claim 1, wherein the first biasing member comprises a spring.

6. The system of claim 1, further comprising:
a second idler mounted proximate the second end of the axle and in rotatable contact with the track of the track-driven vehicle;
wherein the first idler is mounted proximate the first end of the axle.

7. A system comprising:
a first and second frame member disposed opposite each other, each frame member comprising an adjustment slot;
a first cross member, with a first end and a second end, the first end of the first cross member detachably coupled to the first frame member and the second end of the first cross member detachably coupled to the second frame member;
an axle, with a first end, a second end, a forward position, and a rearward position, detachably coupled to the first and second frame members via the adjustment slot with an axle bolt;
at least one idler mounted on the axle and in rotatable contact with a track of a tracked-vehicle; and
first and second biasing members, each with a first end and a second end, the first ends pivotally coupled to the first cross member and the second ends pivotally coupled to the axle;
wherein the first and second biasing members move the axle between the forward position and the rearward position to tension the track.

8. The system of claim 7, where a first biasing member is coupled to the first end of the axle; and
wherein the second biasing member is coupled to the second end of the axle.

9. The system of claim 7, wherein at least one of the first and second biasing members comprise pneumatic shock absorbers.

10. The system of claim 7, wherein at least one of the first and second biasing members comprise springs.

11. The system of claim 7, further comprising:
an adjustment collar coupled to the second end of each of the first and second biasing members to pivotably couple the two biasing members to the axle.

12. The system of claim 7, further comprising:
a second cross member, with a first end and a second end, the first end of the second cross member detachably coupled to the first frame member and the second end of the second cross member detachably coupled to the second frame member; and
a roller, disposed on the second cross member, to guide the track.

13. The system of claim 7, wherein at least one of the first and second frame members further comprises a wear guard disposed on a bottom surface of the frame member where the track travels over the frame member in use.

14. The system of claim 13, wherein the wear guard comprises ultra-high molecular weight (UHMW) polyethylene (PE).

15. The system of claim 7, wherein the track has a range of allowable tensions; and
wherein the first and second biasing members are configured to maintain the track tension within the range of allowable tensions when the axle is between the forward position and the rearward position.

16. The system of claim 7, wherein the track has a range of allowable tensions; and
wherein the first and second biasing members are configured to provide a maximum allowable tension of the range of allowable tensions when the axle is in the forward position; and
wherein the first and second biasing members are configured to provide a minimum allowable tension of the range of allowable tensions when the axle is in the rearward position.

17. A method comprising:
lifting at least a portion of a track-driven vehicle off the ground;
loosening an axle bolt securing an axle to a track guide of the track-driven vehicle to enable one or more biasing members to move an axle rearward in adjustment slots on the track guide to tension a track;
tightening the axle bolt to secure the axle to the track guide; and
lowering the portion of the track-driven vehicle to the ground.

18. The method of claim 17, wherein the at least a portion of the track-driven vehicle comprises a rear swingarm and track of the track-driven vehicle.

19. The method of claim 17, further comprising:
riding the track-driven vehicle to bring the track up to operating temperature prior to lifting the track-driven vehicle.
